(19) United States
(12) Patent Application Publication
(10) Pub. No.: US 2013/0090995 A1
(43) Pub. Date: Apr. 11, 2013

(54) Advertisement finder

(71) Applicant: Jerry Forrester, Toronto (CA)

(72) Inventor: Jerry Forrester, Toronto (CA)

(21) Appl. No.: 13/317,007

(22) Filed: Oct. 7, 2011

(51) Int. Cl. G06Q 30/02

(52) U.S. Cl. 705/14.4

(57) ABSTRACT

The invention relates to advertisements finder, a new medium for advertising, employing a computer system and a plurality of portable devices, for providing advertisements on a constant basic to consumers of products and services, in a convenient and easy to handle form. Advertisements finder portable devices is for use in place of paper for daily advertising, by providing a device suitable for easy handling which will provide displayed advertisements information on a day to day basic, and will further provide options such as providing credits on memory cards for consumers to take advantage of advertised credits for products and services.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND

1. Field of the Invention

Grocery stores and supermarkets commonly supply consumers with loose leaves papers advertising their products. Such method of advertising products and services are also use by hardware stores, clothing stores, furniture stores and many other types of stores, in order to bring attention to their products and services, to consumers.

The invention relates to an electronic medium, for advertising products and services available to consumers and potential consumers from advertisers.

2. Description of Prior Art

Shoppers usually rely on numerous mediums, to obtain information on products for sale from a variety of retailer outlets. It is apparent that an abundance of paper, time and cluttering accumulate, due to frequent distribution of papers advertising different products and services, being delivered to homes and businesses. Grocery stores and supermarkets commonly supply consumers with piles of papers containing weekly and sometimes daily advertisements, of products and services. Originally these papers created several types of problems in such a way as to be a fire hazard, an eye sore and a contributor to depletion of forest on a global scale. Although paper advertising provided an available medium to advertise for consumers originally, it must be phased out from such over whelming daily use.

Fast food restaurants can distribute ADVERTISEMENTS FINDER displaying devices, to customers and potential customers, so that updated information concerning their products and services can be readily available to those customers. Promoters for small businesses, and private organizers of functions or services, can seek to include their advertisements with other popular advertisements of products and services being advertised in ADVERTISEMENTS FINDER by popular companies, which will expose their products or services to more viewers. The present invention will benefit consumers by providing convenient and up to date information, on products and services every day. The present invention will also benefit companies, by saving them money from purchasing, printing and distributing paper, advertising their products or services. Stores such as a hardware store using ADVERTISEMENTS FINDER for advertising their products, can provide a page or more in ADVERTISEMENTS FINDER, for placing advertisements for plumbers, electricians, carpenters, etc, which will benefit a consumer who may be doing home repairs and are looking for a plumber, or a consumer who is a plumber that advertised his service with a hardware store in ADVERTISEMENTS FINDER.

Method and Apparatus for Displaying, According to:
U.S. Pat. No. 6,594,673. Jul. 15, 2003. Visualizations for collaborative information.
U.S. Pat. No. 6,910,186. Jun. 21, 2005. Graphic chatting with organizational avatars.
U.S. Pat. No. 7,124,164. Oct. 17, 2006. Method and apparatus for providing group interaction via communication networks.
U.S. Pat. No. 7,133,900. Nov. 7, 2006. Sharing and implementing instant messaging environments.
U.S. Pat. No. 7,152,093. Dec. 19, 2006. System for real-time communication between plural users.
U.S. Pat. No. 7,206,809. Apr. 17, 2007. Method for real-time communication between plural users.
U.S. Pat. No. 7,433,921. Oct. 7, 2008. System for real-time communication between plural users.
U.S. Pat. No. 7,825,904. Nov. 2, 2010. Information processing apparatus and storage medium storing item selecting program.
U.S. Pat. No. 4,674,040. Jun. 16, 1987. Method for displaying and integrating commercial advertisements with computer software.
U.S. Pat. No. 6,535,204. Mar. 18, 2003. Manuscript input data processing device. These inventions employ cellular phones display screens, computer system display screens, and other available display screens including flexible display screens. Furthermore these inventions, although they provide information on display screens, they do not provide an alternate means from paper for providing advertisements, to people at home, in businesses, in transit or in their back yard.

ADVERTISEMENTS FINDER provides an alternate method of providing advertisements to people, without having to use news papers and other form of paper advertisings.

### SUMMARY

In accordance with the present invention a medium for providing advertisements includes a plurality of portable electronic display devices employing a computer system comprising a central processing unit adapted for communication with the plurality of portable and updateable electronic display devices with memories. The portable electronic display devices, comprising housings and are of suitable sizes for easy handling, suitable weight for easy carrying, and suitable colors for customers to choose from, and pictorial outer sides providing windows to displays, memory transposition ports, page forward buttons, page reverse buttons, keypads and select buttons. The portable electronic display devices windows may also provide access to touch pads which is operatively connected to pointer means, and the windows may further provide access to touch screen displays. The keyboard, the touch pad and the touch screen displays can be use to navigate to locations on the portable electronic display devices displays. The present invention comprising a rechargeable power source and storage element, disposed at a predetermined location for providing power, so that the invention can function. The present invention further providing display screen visible through a window, a memory transposition port accessible through a window for obtaining credits on a memory card, a control panel also visible through a window for controlling a pointer which can be manipulated to view and select different location from a body of information available from a memory. ADVERTISEMENTS FINDER does not use paper as a product use for advertisings. It will prevent the build up of loads of discarded papers, delivered from stores and super markets, in homes and businesses daily. The invention will not use paper, radio or television to advertize products and services. ADVERTISEMENTS FINDER will provide daily updates for products being advertized and for new products, as well as providing coupon credits on a memory card, thereby providing a much needed medium which consumers can use for obtaining daily updated information, from manufacturers, whole sellers and distributors of goods, and service providers.

Accordingly several objects and advantages of the invention are to provide an improve medium for advertising. To provide means of increasing the availability of a medium containing daily advertising. To provide a medium for advertising with increase user options, and to provide a more user-friendly, yet economical form of advertising. Still further objects and advantages will become apparent from a study of the following description and the accompanying drawings.

### BRIEF DESCRIPTION OF THE SEVERAL VIEWS OF THE DRAWING

FIG. 1, Is a prospective view illustrating three cooperating computer components, of a computer system.

FIG. 1-A, is a perspective view of three portable display devices adapted for communication with the computer system, and also a memory card for storing and transporting predetermined information, stored on a portable display device, which a consumer can use when shopping at stores participating in advertising their products and services in ADVERTISEMENTS FINDER.

FIG. 2, is a perspective view of a single screen portable display device of the present invention, which comprises a control panel and a plurality of access ports.

FIG. 3, Is a perspective view of a single screen touch screen portable display device of the present invention, illustrating a touch screen device and comprises a plurality of access ports.

FIG. 4, Is a perspective view of a duel screen portable display device in an open form, of the present invention, showing two display screens, a control panel, a plurality of access ports, and a memory card.

FIG. 5, is a perspective view of a housing for a single screen portable display device of the present invention, showing the front face side of a housing comprising a plurality of windows for exposing a display screen, and a control panel, and also shows ports on a front vertical side for power connection, for signals connections and for memory transposition port thereof.

FIG. 5A is a perspective view of a back portion of a portable display device comprising, a printed circuit board and communication connections.

FIG. 6, is a perspective view of a case or protective covering for a duel screen portable display device of the present invention, in a closed form, showing a memory card pocket and the invention name disposed on its outer front side thereof.

FIG. 7, is an illustrative view of the cases shown in FIG. 6, in an open form, for a duel display screen portable display device, of the present invention.

FIG. 8, is an illustrative view of a case or protective covering for a single screen portable display device of the present invention, comprising a display screen window, a control panel window, a elastic keeper skirt and a swing flap as a front cover which comprises a memory card pocket inside wall thereof.

FIG. 9, is a illustrative view of a case for a single touch screen portable display device of the present invention, comprising a display screen window, an elastic keeper skirt and a swing flap front cover having a memory card pocket disposed on its inner front side wall thereof.

FIG. 10, is a perspective view of a device for reading memory which comprises a display screen and a memory card slot.

FIG. 11, is a comprehensive view of a flow chart illustrating directions in which information travels.

### REFERENCE NUMERALS IN DRAWINGS

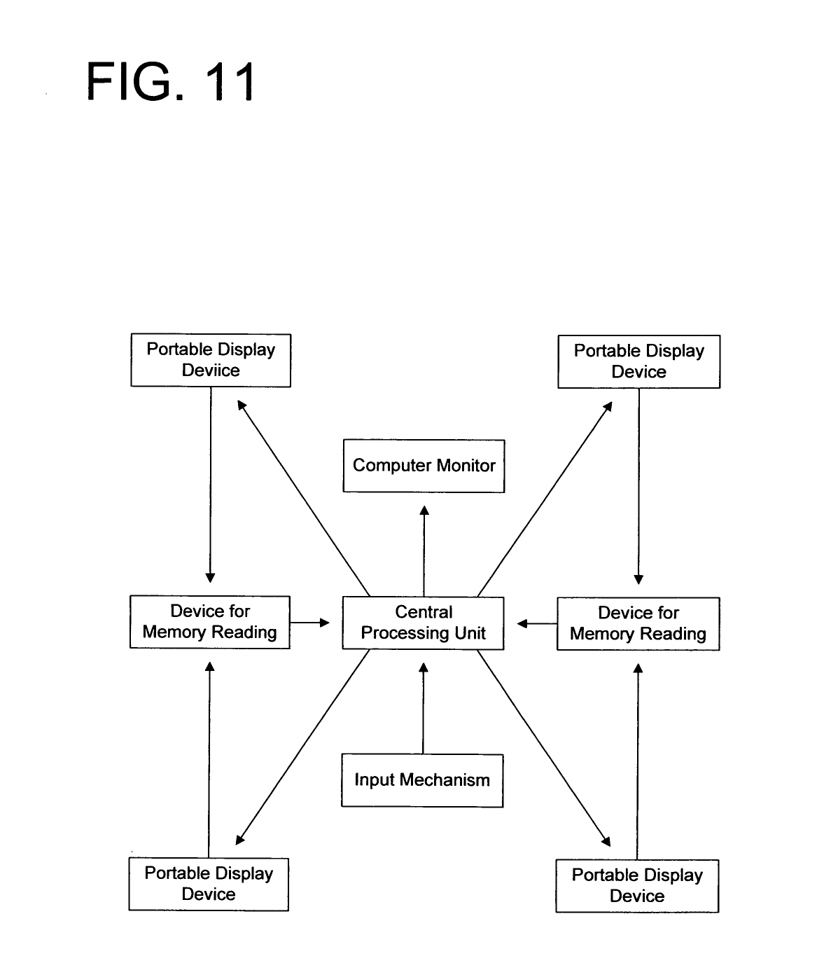

10 Control panel operated, single screen portable display device, comprising
12 Housing
13 ON and off key
14 Power transmission port
15 Signal transmission port
16 Phone line port
17 Computer component line port
18 Memory transposition port
19 Memory card
19A Magnetic strip on memory card
30 Display screen
61 Control panel
60A keys
62 Scroll pad
63 Select key
64 Option key
65 Horizontal direction bar
66 Vertical direction bar
10A Control panel operated, single screen portable display device
11A Page forward key
11B previous page key
12A Housing
13 ON and off key
50 Control panel operated, duel screen portable display device
52 Left side display screen
53 Flexible conductive joiner
54 Right side display screen
55 Housing
61 Control panel
62 Scroll pad
63 Select key
64 Option key
65 Horizontal direction bar
66 Vertical direction bar
13 On and off key
14 Power transmission port
15 Signals transmission port
16 Phone line port
17 Computer component line port
18 Memory transposition port
20 Touch screen operated, single screen portable display device
13 On/off key
14 Power transmission port
15 Signals transmission port
16 Phone line transmission port
17 Computer component line port
18 Memory transposition port
22 Housing
40 Display screen
25 Central processing units, comprising
26 Hard disk drive port
27 Floppy disk port
28 Housing
24 Computer monitor
21 Housing
22R Brightness key
22L Darkness key
23 Display screen
56H Housing for panel control single screen portable display device, comprising:
56 Housing front
57 Display screen window
73 Control panel window
13A On/Off key access window
14A Power port access window
15a Signals port access window
16A Phone line port access window
17A Computer component line access port window
18A Memory transposition port window
59 Base or back portion, of a portable display device and housing, comprising:
59H Housing back portion
59C Ridge
100 Printed circuit board
101 Display connection
102 controls connection
103 Battery
104 Device for memory
105 Memory controller
106 Screws
70 Case includes:
70P Pocket
71 Left window
72 Right window
73A Control panel window
74 Elastic skirt
80 Case includes:
70P Pocket
73A Control panel window
74 Elastic skirt
82 Display window
90 Case includes:
70P Pocket
74 Elastic skirt
92 Display screen window
110 Device for memory reading includes:
112 Display screen
114 Memory card slot
FIG. 11 Floor chart

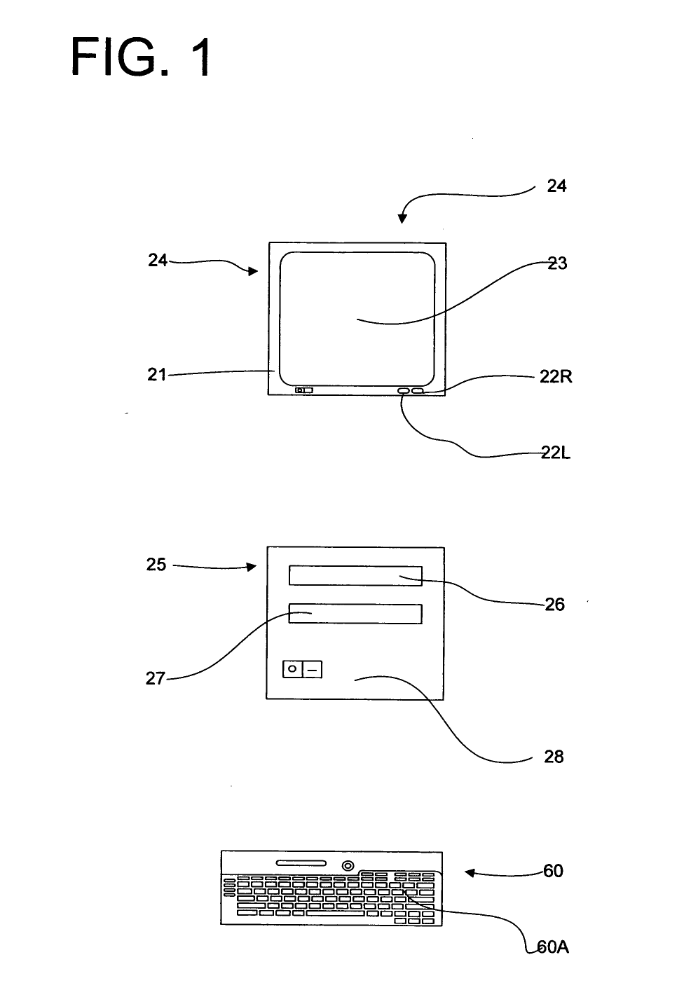

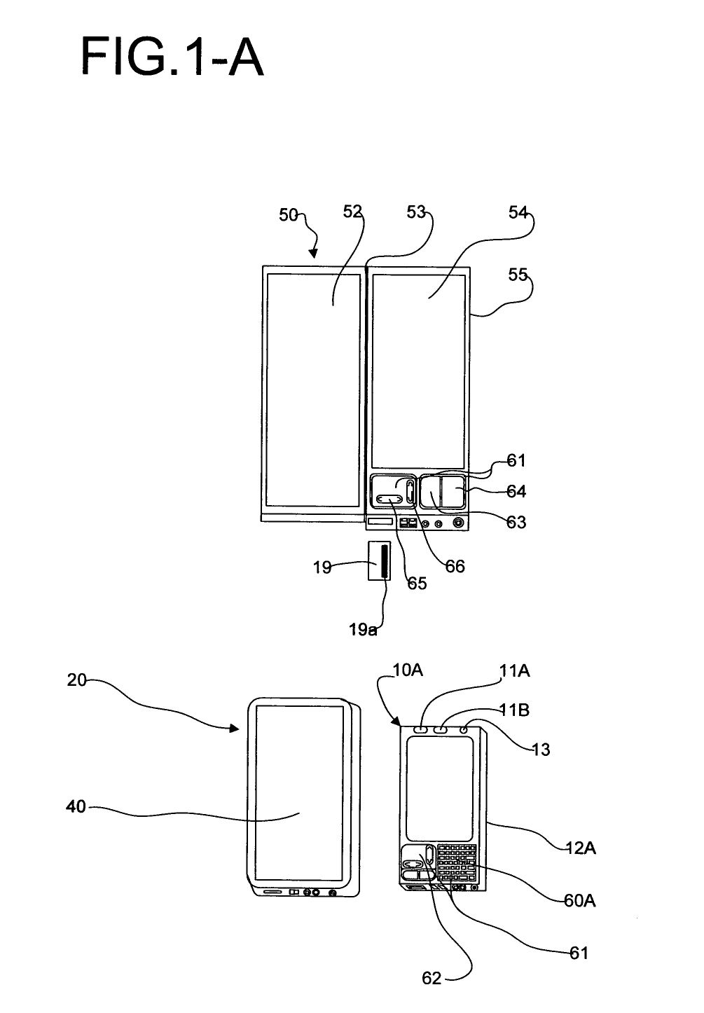

Reference Numerals and Descriptions of FIG. 1 to FIG. 9, in the Drawings:

FIG. 1-A shows three, portable display devices 10A, 20 and 50, and also a memory card 19, having a magnetic stripe 19A, on one side of its flat surface. Device 10A illustrates, switch 13 to turn on and off device 10A, page forward key 11A, and previous page key 11B, housing 12A, control panel 61, Keys 60A, and scroll pad 62. Device 20 illustrates, touch screen display 40. Device 50, illustrates, a duel screen panel control device showing left display screen 52, flexible conductive joiner 53, right display screen 54, housing 55, control panel 61, keys 60A, and scroll pad 62. Devices 10A, 20 and 50, as shown in FIG. 1-A, are adapted for receiving information from the computer system shown in FIG. 1 comprising, keyboard 60 having keys 60A thereof, central processing unit 25, having hard disk drive port 26, floppy disk drive port 27 disposed through its frontal elongated vertical wall, and housing 28 for housing internal elements of central processing unit 25. Monitor 24, shows display screen 23, brightness key 22R, darkness key 22L and housing 21

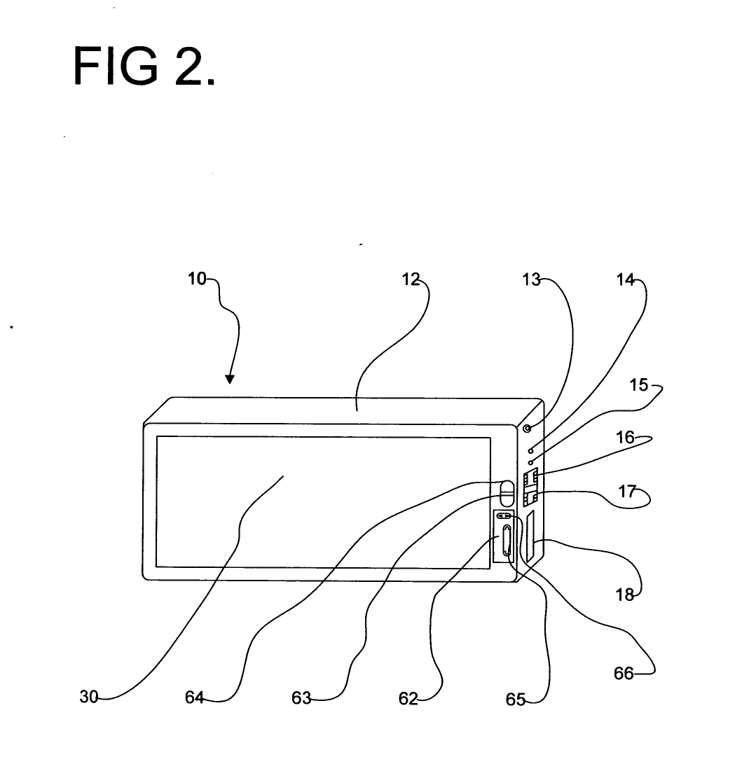

FIG. 2, illustrates a single screen panel control portable display device 10 comprising, housing 12, for housing the device elements, on and off key, for turning device 10 power on and off, power transmission port 14, for providing external connection to power source, signals transmission port 15, for optional use to transmit signals, phone line port 16, for optional use to transmit signals using a phone line connection, computer component line access port 17, for optional use to connect a computer component to the device, memory transposition port 18, for communicating information with memory card 19 shown in FIG. 1, display screen 30, for displaying stored information, scroll pad 62, for navigating a pointer through information displayed on display 30, select key 63, for selecting specific parts of information displayed on display 30, option key 64, for selecting menu options, horizontal arrow bar 65, for horizontal directional movements and vertical arrow bar 66, for vertical directional movements.

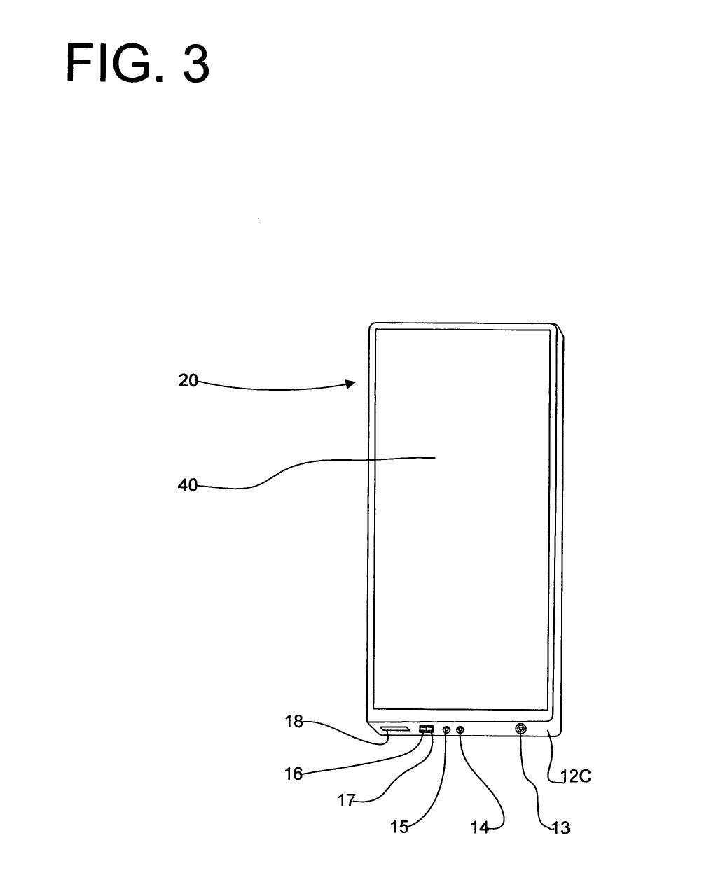

FIG. 3, illustrates a single touch screen portable display device 20, of the invention comprising, display screen 40, having touch screen technology, for manipulation of information displayed on display 40. Device 20 in FIG. 3, also shows a on and off key 13, for turning device 20 on and off, power line connection port 14, for connecting to external power source, signals transmission port 15, for transmitting signals to and from device 20, phone line port 16, for optional use, using phone line for communicating information, computer component line port 17, for optional use, using direct connection to a computer system, so that information can be transmitted to and from device 20 and the computer system, memory transposition port 18, for transferring information onto memory card 19 shown in FIG. 1.

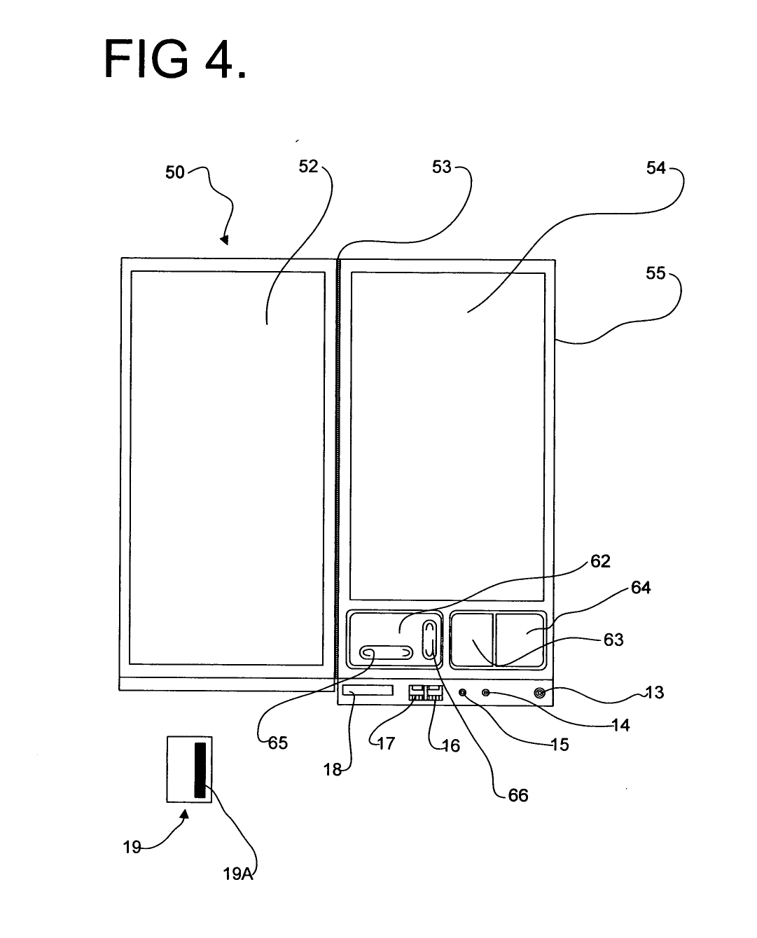

FIG. 4, illustrate a panel control duel screen portable display device 50, and a memory card 19 having a magnetic stripe 19A thereof. Device 50 shown in FIG. 4, further illustrates, a left side display screen 52, for displaying a first page of advertisements, a right side display screen 54, for displaying the next page of advertisements, a flexible conductive joiner 53, for linking and enabling swinging movements of device 50, left side 52 and right side 54, a housing 55, for keeping device 50 in a functional and protective position, scroll pad 62, for enabling manipulation of a pointer not shown in the drawing appearing in the displayed pages, select key 63, for enabling selection of certain information displayed on displays 52 and 54, option key 64, for selecting menu options available in device 50, horizontal arrow bar 65, for showing horizontal movement available using scroll pad 62, vertical arrow bar 66, for showing vertical movements available using scroll pad 62, on and off power switch 13, for turning device 50 power on and off, power access port 14, for enabling external power connection to device 50 power source, signals transmission access port 15, for enabling transmission of signals to and from device 50, phone line access port 16, for enabling direct phone line connection, computer component access port 17, for enabling direct connection between device 50 and a computer system, and memory transposition port 18, for enabling accessibility of memory card 19, so that information selected from a body of information displayed on device 50 displays 52 and 54, can be transferred onto memory card 19, for use later.

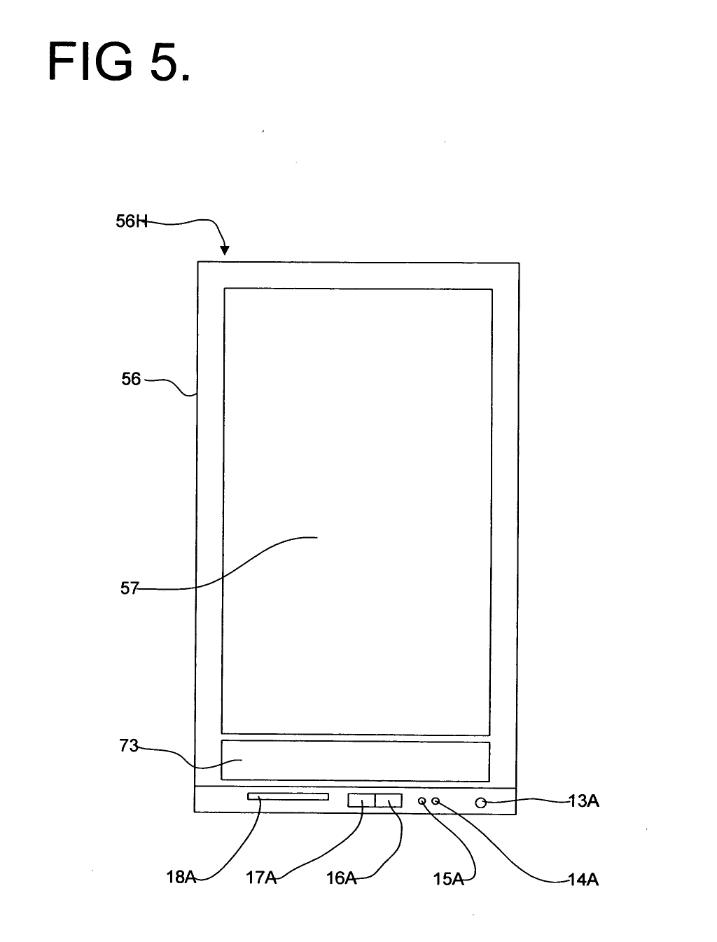

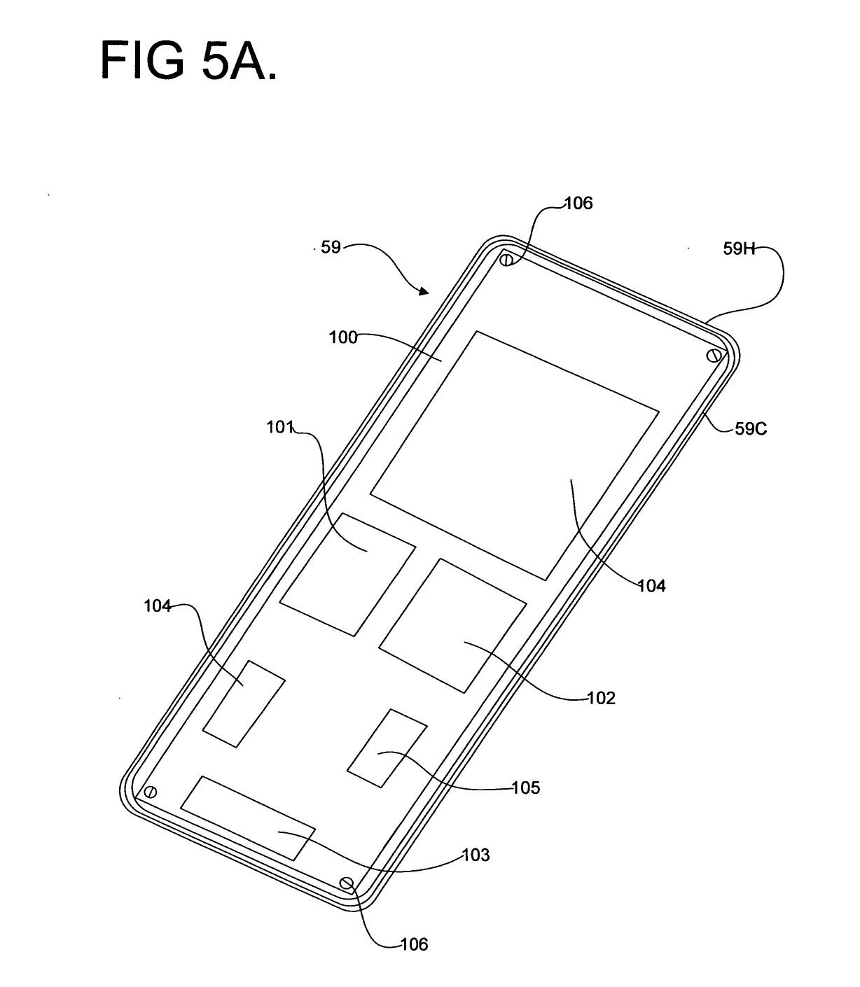

FIG. 5, illustrates a typical housing 56H of a portable display device showing the outer side of front face 56. Housing 56H front 56 includes a vertically configured elongated window 57, predeterminly positioned through its frontal face side thereof, for accommodating and exposing a display screen. Housing 56H front 56 further includes a horizontally configured elongated window 58, predeterminly positioned through its lower frontal face side thereof, for accommodating and exposing a control panel. Housing 56H front 56 having a front vertical wall comprising, window 13A, for exposing a switch, window 14A, for exposing a power port, window 15A, for exposing a signal port, window 16A, for exposing a phone line connection port, window 17A, for exposing a computer component line connection port, window 18A, for exposing memory transposition port 18 thereof.

FIG. 5A, illustrates base 59 of a typical portable display device of the present invention. Base 59, includes housing 56H back portion 59H, for keeping in place printed circuit board 100. Back portion 59H having encircling ridge 59C positioned on its outer diametrical rim, for enabling back 59H to snap and seal to the circumferential underside outer edge of housing 56H front 56. FIG. 5, show front 56 without any of the common components found on all portable visual communicating devices. Where as in FIG. 1, base 59 and back 59H is kept together with screws 106, and is interlock with front 56 by way of ridge 59C snapping into front 56 underside, thereby showing a portable display device in an assembled and closed form, comprising the common components found on most portable electronic visual communicating devices. Base 59 including printed circuit board 100, includes a display screen connecting plug 101 and a input mechanism connecting plug 102, a battery 103, typically rechargeable, providing the power source for a portable display device of the present invention functions, and also may include solar power means, as a power source, not shown in the drawing. Printed circuit board 100, is kept in place with screws 106 and typically includes a device for memory 104 and a memory divider 105, predetermine disposed thereof. Printed circuit board 100 is adapted for accommodating touch screen and other available displays which can be use with the present invention. Basic mobile service will allow users of ADVERTISEMENTS FINDER, to receive information from a computer system using compatible program software.

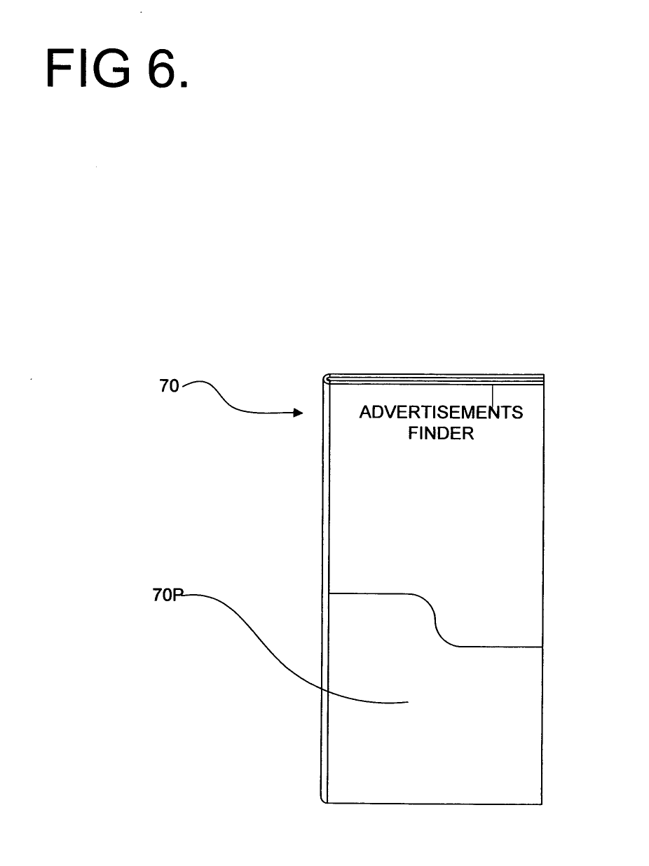

FIG. 6, illustrates a protective covering or case 70, for a duel screen information displaying device showing a pocket 70P position a its frontal surface area, which accommodate memory card 19, pocket 70P, and the title of the invention. Case 70 can be made out of plastic and or other suitable materials. Case 70 may include a plurality of shapes, sizes and colors thereby providing customers with options, such as case 70 matching a customer's logo.

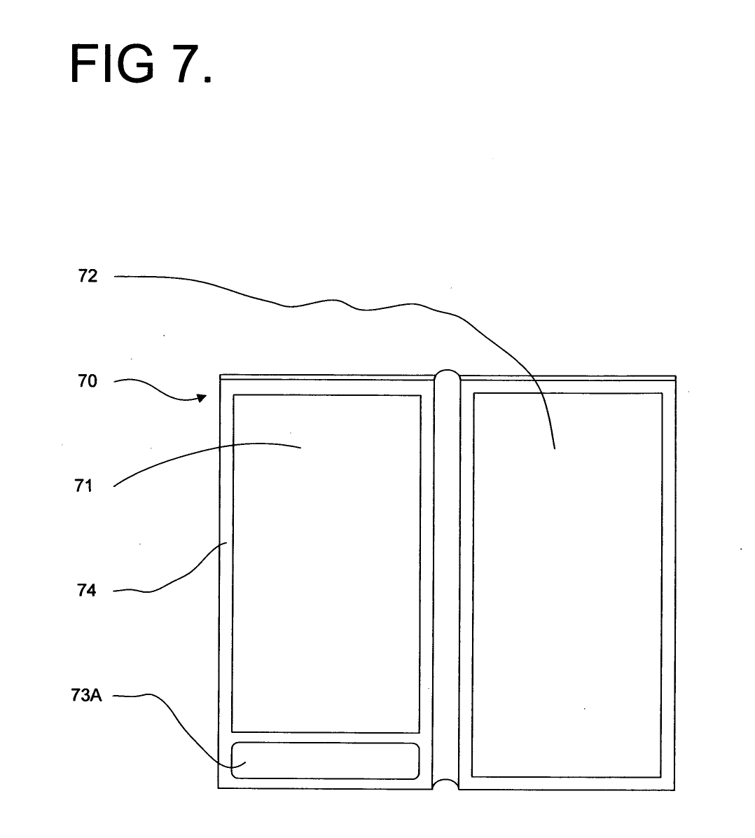

FIG. 7 illustrates case 70 opened comprising, left side display window 71, right side display window 72, control panel window 73 and elastic retaining skirt 74, which keeps a portable device of the present invention functioning in a secure and protective covering.

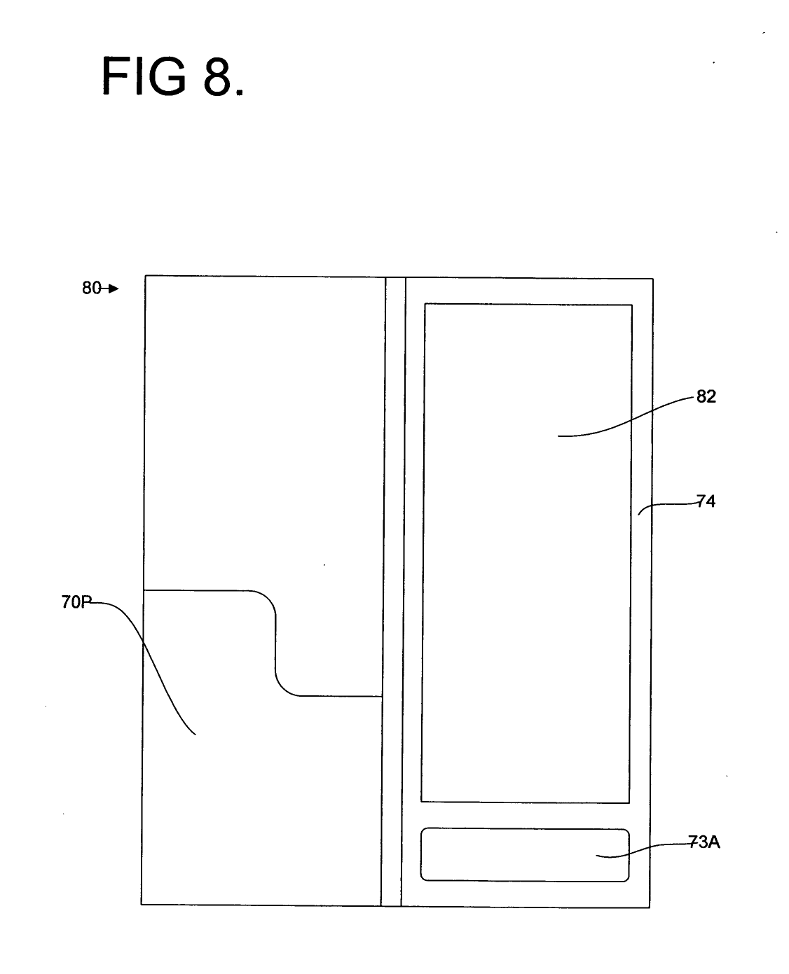

FIG. 8, illustrates a open case 80, exposing a inner side pocket 70P on its flap or cover side, and exposing a right side display window 82, a right side control panel window 73, and resilient overlapping skirt 74, for keeping in place a portable device.

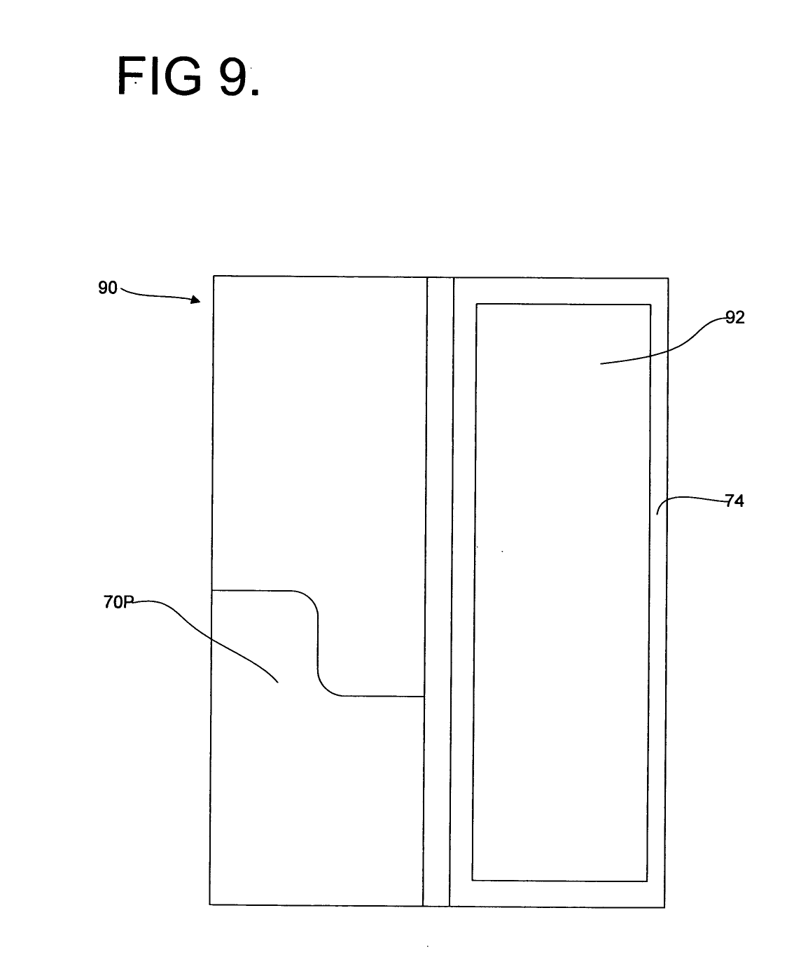

FIG. 9, illustrates an open case 90, exposing an inner side pocket 70P positioned on its right side flap or cover inside wall. Case 90 includes display screen window 92, and elastic overlapping skirt 74, for keeping in a protective and secure position, a single display touch screen, portable display device, of the present invention.

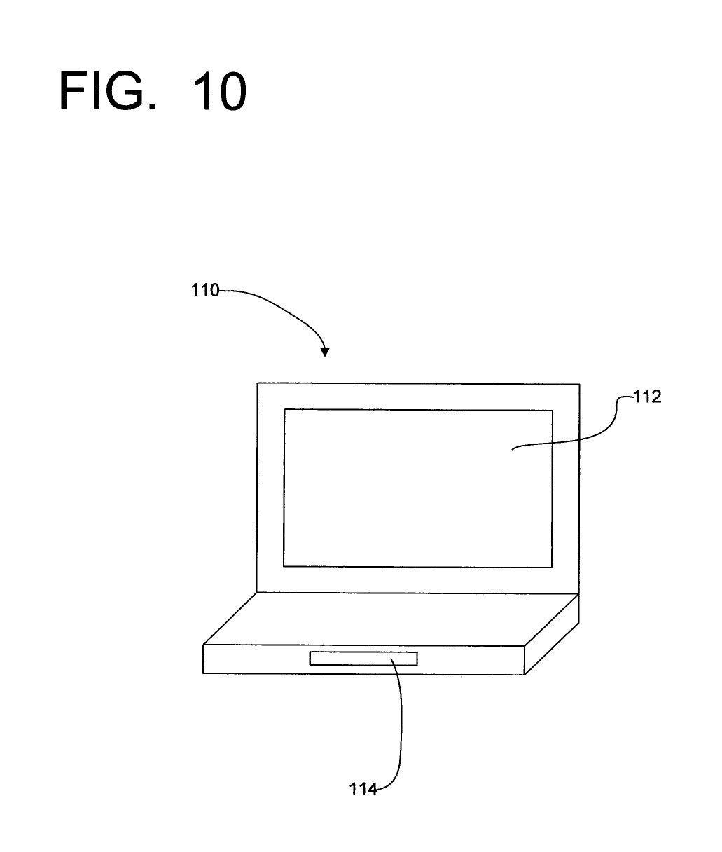

FIG. 10, illustrates a device for reading memory 110, which retrieves predetermined portions of advertisements stored on a memory card. Comprising a display screen 112, for displaying any information retrieved from the memory card by the device for reading memory. Also having a slot 114, in which can slide in and out the memory card. The device for reading memory further comprising, power and signals lines connecting ports not shown in the drawing, for external power input and signals transmission.

FIG. 11, comprehensive view of a floor chart of the present invention illustrating directions transmitting advertisements information travels. The floor chart shows a input mechanism communicating information to a computer central processing unit which, communicates the information to a computer monitor and a plurality of portable display devices. The plurality of portable display devices transmit predetermined exerts of information onto a memory card which communicates the information to the computer central processing unit for processing and can be displayed on the computer monitor display.

### DETAILED DESCRIPTION OF THE INVENTION

The invention relates to a method for advertising using a computer system, and a plurality of portable display devices, for transmitting information for displaying, on said portable display devices, employing the known comprising:

A plurality of computer components, comprising a computer monitor which is operatively connected to and is in communication with a central processing unit, and the central processing unit is operatively connected to a keyboard. The computer system is in communication with a plurality of portable display devices so that information can be transmitted from the computer system, to the plurality of portable display devices. The information transmitted from the computer system to the plurality of portable display devices, can be viewed on the computer system's monitor, and can be altered, deleted or new information can be added, to the body of information transmitted to the plurality of portable display devices. The computer system is operated by a human operator, employing the keyboard to input information through the computer system central processing unit, via to the plurality of portable display devices, so that a human user of a portable display device can access the communicated information inputted by the human operator of the computer system. A consumer using a portable display device can search for and have displayed on a portable display device display, information which includes advertising of products such as groceries. The consumer can obtain credit for discounts for the products, on a memory card adapted to store predetermined portions of information from the advertisements displayed on the portable display device display.

The invention further employ a program software, not shown in the drawings, to be programmed in the computer system central processing unit and is stored thereto in a device for memory. The program software enables manipulation of information going in and out of the computer system central processing unit. The program software also enables the manipulated information in the computer system central processing unit, to be transmitted into the plurality of portable display devices where it can be displayed, on the plurality of portable display devices displays.

The plurality of portable display devices of the invention further comprising a plurality of devices for memories. A device for memory is disposed in each portable display device, at a predetermined location thereof.

The present invention further employ a storage network, not shown in the drawings, so as to distribute information from the computer system central processing unit, to the plurality of portable display devices. A keyboard can be use to input information into the computer system central processing unit, and through the plurality of computer components, via the plurality of portable display devices.

The invention also employs a plurality of memory cards for communicating information from the plurality of portable display devices to the computer system central processing unit. The invention may transmit useful signals wirelessly or through phone or cable line connection, so that information can be communicated to and from the computer system central processing unit and the plurality of portable display devices.

The invention employs a key pad comprising keys and a pointer. The pointer is use to navigate through information displayed on a portable display device display. The pointer is also use to select specific portions of information displayed on a portable display device display.

The invention may also employ a touch screen display device, to navigate through the information displayed on a portable display device display, and to select specific portions of information displayed on a portable display device display.

A portable display device of the present invention comprises, a memory transposition port disposed through a front vertical side wall of a portable display device. The memory transposition port is configured for accommodating a memory card and is adapted to allow transmission of information from the plurality of portable display devices, onto a memory card which is adapted to allow transmission of stored information to be transmitted into the computer system central processing unit.

A portable display device of the present invention further comprises, a control panel disposed on an outer flat frontal horizontal surface of a portion of a portable display device. The control panel includes a pointer device and a zoom feature, not shown in the drawings, so that a human operator of a portable display device can manipulate the pointer device to zoom in and out on information displayed, on a portable display device display. The pointer device allows a user of the portable display device to access and navigate through any body of information displayed on the portable display device display. A human operator of the computer system, may input information into the computer system central processing unit, concerning advertisements of products and services. The inputted information may then be forwarded to a plurality of portable display devices which keeps the forwarded information stored in a device for memory disposed thereof. The information stored in the plurality of portable display devices, is available for a human operator of a portable display device to access and view, and also to transmit predetermined excerpts from advertisements information onto a memory card.

A memory card is provided for use as a storage medium, to store predetermined portions of information which can be use to obtain discounts on products and services advertised in the plurality of portable display devices. The memory card is made from a plastic material, and is configured so it can be inserted into a portable display device memory transposition port where information can be transmitted onto it, and it is also configured to be removed from the memory transposition port of the portable display device and can be inserted into a device for reading memory comprising a memory card slot, and the device for reading memory will read, any specific portions of advertisements information stored on the memory card. The memory card may be carried around in a person pocket, wallet or purse, for convenience and accessibility to use when shopping. The memory card can also be kept in a card pocket, provided in the protective covering or case which is configured to accommodate and protect the portable display device of the present invention.

Some common components included in a portable display device of the present invention comprises, is a device for memory which store information, a display screen for displaying stored information, a control panel comprising keys and a pointer device, for navigating through and selecting portions of information from any information being displayed on a portable display device display. A portable display device of the present invention further comprises, a plurality of power and signals ports disposed on its front vertical side wall thereof. The power and signals access ports are configured to enable an external power source to plug-in, and to enable signal conducting lines to plug-in. The power access port enables power to enter a portable display device, and to charge a power storage unit in order to provide power for the portable device to function. The power storage unit may include a rechargeable battery disposed inside the portable display device.

The invention relates to a medium which provides useful information on portable devices so that humans can use for shopping and for being inform of competitive prices and availability of products and services, on a day to day basis, from manufacturers and distributors of advertised products, on said portable display devices, of the present invention.

The invention further comprises a virtual advertising method for providing advertisements functions, and includes a plurality of portable electrical devices. The plurality of portable electronic devices, displays advertisements on their display screens. The electronic devices are configured so that a user can access information on advertisements, by way of manipulating a control panel having keys or a touch screen device. The invention provides a useful tool for consumers to take advantage of goods and services advertised at discount prices, on the plurality of portable electronic devices.

Further objects and advantages of the invention are:
(a) To provide a medium for advertising through electronic means which includes the plurality of portable display devices which can be made from plastic, metal and other suitable materials or from a combination of materials such as plastic, metal and glass, with windows and a strong enough body, and which can be produce in a variety of colors and shapes and also be of suitable weight and size for practical ease of using and needfulness.
(b) To provide a control station or work station from which a human computer operator can input information into a computer system, which includes a plurality of computer components.
(c) To provide a device housing comprising windows, and which provides a protective and workable housing for the plurality of portable display devices so that users of those portable devices can easily access a plurality of ports available with attachable applications for power and signals transmissions.
(d) To provide an advertising medium, comprising a computer and a central processing unit, employing a key board for inputting and manipulating information to and from the computer central processing unit, and for communicating information from the computer central processing unit via, the plurality of portable display devices, of the present invention.
(e) To provide a device for memory, which is able to store a plurality of characters and shapes in said memory, beginning at an address corresponding to said polurality of characters and shapes, for displaying on the plurality of portable display devices of the present invention, which receives characters and shapes for displaying on displays.
(f) To provide a program software, adapted to enable a human computer operator, to input, send, alter or delete characters and shapes inputted or being inputted in the program software, in a memory at an adjacent series of addresses.
(g) To provide a human operator to operate a computer system, to manipulate functions provided by the computer system and a suitable program software, to enable transmission of information to and from the computer system, via the plurality of portable display devices, of the present invention.
(h) To provide a display operatively connected to a memory, and which display a plurality of characters and shapes stored in the memory at adjacent series of addresses.
(i) To provide a keypad comprising a pointer which can be manipulated by a user, of a portable display device, to point and select or skip pages for advertisements and other information, displayed to any location between any adjacent characters and shapes on the plurality of portable display devices displays, of the present invention.
(j) To provide a memory controller, for directing any additional characters and shapes, which a human operator of a computer system adapted for use with the plurality of portable display devices, enters via the character and shape input program, to a location in the portable devices memory beginning at an address corresponding to the location between a adjacent characters and shapes displayed on a display, so that new information can be added to information contained in the portable display devices, thereby all information contained in the portable display devices can be transposed.

The present invention includes the plurality of portable display devices, for communicating advertising information to consumers. The portable display device comprises a housing which can be made from plastic and other suitable materials, and can vary in size and shapes, depends on a customer's choice. The housing includes windows predetermindly positioned for accessing a plurality of keys, ports and displays thereof. The plurality of portable display devices housings, houses a plurality of elements, of which some are not shown in the drawings, adapted for receiving and for displaying information transmitted through a computer system, using compatible program software.

The invention further comprises, computer components, which makes up the computer system, and applicable program software adapted for communicating information to, the plurality of portable display devices. The plurality of portable display devices of “ADVERTISEMENTS FINDER”, can have a pictorial outer appearance, and can be placed and be use on a human lap, on a table, in a car, at work or while walking.

The invention further comprising, a plurality of devices for reading memory, which will retrieve and display information stored on a plurality of memory cards.

The plurality of portable display devices, of the present invention, further comprises memory for holding information, a key pad for using the information, and plugs accessories. The plurality of portable display devices will receive downloads from a computer system, operated by a human. Such downloaded information contained in the portable devices can be altered, remove or delete, by an operator using compatible program software with a computer system. All information can be adjacent addresses so that information can be moved or altered without having to be reenter.

Each portable display device, of the present invention, provides a memory transposition port in which a memory card can be inserted for obtaining specific portions of advertisements information which can later be retrieve, altered or delete while on display on a monitor of a computer system using compatible program software.

A portable display device, of the present invention, may comprise a key board, which keys can be manipulated to view, select, deselect and turn pages, for easy using.

The invention relates to a convenient and easy to use advertising medium which will provide much needed information from retailers, suppliers and manufacturers of products and services to consumers without using paper fliers and News papers.

The included memory transposition port enable a customer to transfer coupon credits on a memory card, for use at participating retailers, suppliers and manufacturers, for advertised discounts on products and services, thereby contributing in using less paper consequently saving some trees.

The invention is not only convenient and easy to use, it is needed to help reduce or stop the use of paper to advertize products on a day to day basis. Supper markets usually supply thousands of paper booklets and other loose leaves papers, advertising a variety of products on sale and for sale. It is obvious to the inventor that an electronic ADVERTISEMENTS FINDER is needed for advertising products and services by companies to potential customers, and for not using paper. Telephone lines and wireless service providers, can provide the connections require for the invention to communicate information, in order to provide a much needed advertising medium.

The invention comprising a computer system employing a central processing unit using suitable program software, which can be manipulated by an operator, and a plurality of portable display devices adapted for customer use at home, in a vehicle or at work. The portable display devices will provide customers with pictures, prices and dates of products and services, that are available at participating companies.

There are some software which provide product information on computer disks. The sole purpose of such computer software is product advertisements. The sole purpose of my invention is to provide advertisements on a plurality of portable devices with display screens. Those devices with displays of the present invention, will continuously receive advertisements from a computer system using a adaptable program software.

Operation:

A method for providing advertisements employing a computer system and a plurality of portable display devices illustrated in FIG. 1., showing a single screen touch screen portable display device 20, comprising a touch screen display screen 40. The touch screen display device 20 enables a user of ADVERTISEMENTS FINDER (the invention), to use the touch screen technology to scroll through pages and advertisements, and to select and transfer information, displayed on the touch screen portable display device 20 display 40, of ADVERTISEMENTS FINDER. The drawing also depict a single screen portable display device 10a comprising a page forward key 11a, a previous page key 11b, a on and off key 13, a housing 12a, a control panel 61, comprising keys 60a, and a scroll pad 62. The control panel 61 includes a pointer, not shown in the drawing, for scrolling through pages and advertisements, and for selecting for transmitting predetermined information, from ADVERTISEMENTS FINDER advertisements. The control panel 61 keys 60A and scroll pad 62, enables users of the plurality of portable display devices of ADVERTISEMENTS FINDER, to manipulate control panel 61 keys 60A or scroll pad 62, to manipulated a pointer, not shown in the drawing, for changing pages and viewing advertisements, and also for selecting and transmitting predetermined information from the advertisements onto memory card 19 when inserted into memory transposition port 18, of a portable display device of ADVERTISEMENTS FINDER.

FIG. 1., further shows a central processing unit 25 comprising, a hard disk drive port 26, a floppy disk port 27, and a housing 28. The central processing unit 25, process and store information inputted by a human operator of a computer system, using a program software, adapted for use with ADVERTISEMENTS FINDER.

FIG. 1., further shows a computer monitor 24 comprising, a housing 21, a brightness adjustment key 22R, a darkness adjustment key 22L and a display screen 23. The computer monitor 24 displays advertisements and other information, on its display screen 23, inputted by an operator of a computer system adapted for use with ADVERTISEMENTS FINDER. The computer monitor 24 can also display advertisements transmitted to a plurality of portable display devices of ADVERTISEMENTS FINDER.

A preferred embodiment of a portable display device of the present invention as illustrated in FIG. 2., prospective view, which shows a single screen portable display device 10, comprising display screen 30, housing 12, on and off key 13, power input port 14, signal transmission port 15, phone line port 16, for optional use, computer component access port 17, for optional use, memory transposition port 18, for transmitting information onto memory card 19, scroll pad 65, comprising horizontal arrow bar 68, showing directions for horizontal movements, vertical arrow bar 66, showing directions for vertical movements, select key 62, for selecting specific advertisements displayed on the portable display device 10 display 30, and option key 64, which enables a user of the present invention to select options available in device 10 menu and for changing selected advertisements, selected from advertisements displayed on the portable display device 10 display 30, of the invention.

An alternate embodiment of a portable display device, of the present invention as illustrated in FIG. 3., shows a single screen portable display device 20, employing a touch screen display 40. Device 20 also shows on and off key 13, power line port 14, signal transmission port 15, phone line access port 16, computer line port 17, memory transposition port 18, and housing 12C. The drawings shows, a plurality of portable display devices 10, 10A, 20, 30 and 50, in which device 20 employ touch screen display technology, which may provide a liquid crystal display having touch screen technology. CONGLOMERATE ADS FINDER further provide a new method to advertise products and services, providing a plurality of portable display devices which includes device 20 comprising, touch screen display 40 which enables a user of the invention to scroll through pages and view advertisements of products and services, while at the same time allowing a user to select, change selection or transmit predetermined portion of selected advertisements, onto memory card 19, shown in FIG. 1., by way of inserting memory card 19 into memory transposition port 18 through which information can be stored onto memory card 19.

FIG. 4., further depict yet another embodiment of a portable display device 50, of the present invention, comprising right side display 52, flexible conductive plastic substrates 53, left side display 54, housing 55, control panel 61, which comprises, select and drag key 62, option key 64, and scroll pad 65, which includes horizontal scroll key 68, and vertical scroll key 66. Portable display device 50, of the present invention, further comprising, on its front vertical side wall, on and off key 13, for turning on and off device 50, plug ports 14, for power input, plug port 15, for signal transmission, plug port 16, for phone line connection, plug port 17, for computer line plug, and memory transposition port 18, for accommodating memory card 19, shown in the drawing having magnetic strip 19a, for storing information thereof.

FIG. 5A., shows a printed circuit board 100, fixedly secured onto back housing 59H, and comprising a device for memory 104 and a memory controller or memory divider 105, connector 101 for a display, connector 102, for connecting a input mechanism, and a rechargeable battery 103 for providing power.

A medium for advertising comprising, a computer system with processing functions for receiving information from a input mechanism and memory transferring devices, and for transmitting information to a computer monitor thereof, and a plurality of portable devices with displays thereof. The plurality of display devices enable information transmission onto a plurality of memory cards. The memory cards is able to be inserted into a plurality of devices for reading memory which transmit information to the computer system for processing.

There are several display devices currently available from manufacturers of liquid crystal display, plasma display, flexible display, electric paper display, which can be use with the present invention.

It should be noted that many portable image storage devices use for storing and viewing can be adapted to function with “ADVERTISEMENTS FINDER” the present invention.

I claim:

1. An article of advertising, for transmitting, storing and displaying advertisements on a plurality of portable display devices, employing the known comprising,
(a) first means to operate with a program software for storing, processing, displaying and transmitting advertisements information, and said first means with said program software further providing an input mechanism for data entering,
(b) said plurality of portable display devices, for storing for displaying and also for enabling transmission of said information includes,
(c) third means for transferring predetermined portions of said advertisements information in said plurality of portable display devices, onto a plurality of storage mediums for enabling transmission of the predetermined portions of said advertisements information to said first means,
(d) fourth means for inputting and transmission of said information, from said first means to said plurality of portable display devices,
(e) fifth means, for retrieving and communicating said information stored on said third means, to said first means,
(f) sixth means, for transmission of power and signals, to and from said first means, and said plurality of portable display devices, so that said first means can function and enable communication to said plurality of portable display devices, so that a human operator of said first means employing said program software for the invention functions, can input said information into said first means, the inputted information is then process, displayed and stored thereof, and the process and the stored said information can be transmitted to said plurality of portable display devices and be stored in a plurality of devices for memory heretofore, so that human users of said plurality of portable display devices can access and view the transmitted said advertisements information on a plurality of displays in said plurality of portable display devices, and the stored said advertisements information in said plurality of portable display devices can also be accessible for transmission onto said plurality of storage mediums and said plurality of storage mediums is adapted to store specific portions of said advertisements information, and the stored specific portions of said advertisements information is communicated to said first means, whereby said human users of said plurality of portable display devices, can select the specific portions of said advertisements information from said plurality of portable display devices and store the specific portions of said information on said plurality of storage mediums which enable transformation of said advertisements information to said first means, and whereby said human users of said plurality of portable display devices can use the specific portions of said information stored on said plurality of storage mediums for obtaining discounts on products and services advertised in said plurality of portable display devices for sale.

2. An article of advertising according to claim 1, wherein a computer system employing said program software to enable, processing, displaying, storing and communicating said advertisements information with said plurality of portable display devices, said computer system includes a monitor for displaying said advertisements information, said monitor is operatively connected to and are in communication with a central processing unit, which are also operatively connected to and are in communication with a keyboard, said computer system is operated by said human operator, and said human operator can use said keyboard to input said information through said computer system to said plurality of portable display devices so that said human users of said plurality of portable display devices can access the communicated said information send by said operator of said computer system through said computer system to said plurality of portable display devices, whereby consumers being said human users of said plurality of portable display devices, can search for and have displayed on said plurality of portable display devices said displays, said advertisements information which includes advertisings of said products such as groceries, and said consumers can also obtain credits for the discounts for said products on said plurality of storage mediums adapted to store predetermined portions of said advertisements information from said advertisements information transmitted from said computer system to said plurality of portable display devices.

3. An article of advertising according to claim 1, wherein said storage mediums is a plurality of memory cards each comprising a magnetic strip on a side thereof.

4. Third means for transferring the specific portions of said advertisements information in said plurality of portable display devices to said first means according to claim 1, where in a plurality of memory transposition ports adapted for accommodating said memory cards and for communicating said advertisements information to and from said memory cards are used, and said memory transposition ports are disposed through a front vertical side wall in each of the portable display devices of said plurality of portable display devices, said memory cards are used for storing the predetermined portions of said advertisements information heretofore, and the predetermined portions of said advertisements information stored on the plurality of said memory cards is transformable to said computer system by way of a plurality of devices for reading memory from the plurality of said memory cards, the plurality of said devices for reading memory retrieves the stored predetermined portions of said information from the plurality of said memory cards and transmit the retrieved predetermined portions of said information to said computer system.

5. Fourth means for transmitting said advertisements information from said first means to said second means according to claim 1, wherein a storage network is use to share said stored information and particularly said keyboard is use to input the information into said computer system, via to said plurality of portable display devices, and also retrieving and communicating said advertisements information from said plurality of portable devices, and said computer system can communicate said information wirelessly through a phone line, through a cable line and also can be done through wireless connection.

6. Fifth means according to claim 1, wherein said fourth means, for retrieving and communicating said information stored on said third means, to said first means is said plurality of devices for reading memory which comprises a plurality of displays, which will display on said plurality of displays, the specific portions of said advertisements information stored on said plurality of memory cards, and the specific portions of said advertisements information displayed through the plurality of said devices for memory reading said displays, can transposed from the plurality of said devices for reading memory to said computer system and can be manipulated by said human operator of said computer system with said program software.

7. Means for inputting and transmitting said information according to claim 1, wherein a input mechanism of the type being a touch screen display device and also a control panel having keys disposed in said plurality of portable display devices thereof, and said touch screen display and said control panel is use to navigate through said advertisements information displayed on said plurality of portable display devices said displays, and said input mechanism enables said users of said portable display devices to select and transmit said predetermined portions of said advertisements information displayed on said plurality of portable display devices said displays.

8. Said plurality memory cards of claim 4 wherein said plurality of memory cards is made from a plastic material and is configured to be inserted into said plurality of portable display devices said plurality of memory transposition ports so that predetermined excerpts from said advertisings can be stored onto said plurality of memory cards, whereby said users of said plurality of portable display devices using said memory cards can store the discount credits and the predetermined excerpts from the advertised said products and services advertised on said plurality of portable display devices, in order to obtain said discounts when purchasing said advertised products and services.

9. Said plurality of portable display devices for storing, for displaying, and also for transmission of said information according to claim 1, wherein said plurality of portable display devices further provides,
(a) A plurality of devices for memory for storing said information for displaying on said plurality of portable display devices said displays,
(b) A plurality of memory controllers for placements of said advertisements information for displaying on said displays in an orderly and clear fashion,
(c) said displays for displaying said information on said plurality of portable display devices said displays,
(d) said control panel comprising said input mechanism, for manipulation of said information displayed on said plurality of portable display devices said displays, and for transmission of said predetermined portions of said advertisements information from said plurality of portable display devices said displays onto said plurality of memory cards,
(e) said plurality of memory transposition ports each comprising a slot for accommodating the plurality of said memory cards and for allowing the predetermined portions of said advertisements information to be transferable to and from the plurality of said memory cards and the plurality of said portable display devices,
(f) a plurality of power and signals access ports in which plugs external power source for powering said plurality of potable display devices and for recharging a rechargeable built in battery in each of the portable display device of said plurality of portable display devices, and also in which plugs said phone line plugs, and said cable line plugs and computer components line plugs.

10. A medium for advertising of the type comprising,
a computer system to operate in conjunction with,
a program software adaptable for providing advertising functions, and also for providing,
memory mapping functions, and said computer system is use as,
a workstation which a human operator can use to control and execute said advertising operation, and said medium for said advertising further comprising,
a plurality of portable electronic display devices, to be use as,
advertisements finders, for providing a virtual advertising function, and said plurality of portable electronic display devices, includes
a plurality of display screens thereof, and said plurality of portable electronic display devices further includes,
a plurality of input mechanism which users of said plurality of portable electronic display devices, can use to cause said plurality of portable electronic display devices to receive users-entry data entered by said users of said plurality of portable electronic display devices, and said users can manipulate said plurality of input mechanism, whereby consumers using said plurality of portable electronic display devices of the present invention, can access said advertisements from said plurality of portable electronic display devices, and whereby said consumer can take advantage of goods and services advertised at discount prices, in said plurality of portable electronic display devices by using,
a plurality of memory cards adapted to be inserted and to fit in said plurality of portable electronic display devices and also can be removed from said plurality of portable electronic devices, and said plurality of memory cards also comprising, means for storing said discount prices for said goods and said services advertised in said advertisements finder, and said plurality of memory cards can be presented to stores advertising said discounts in said advertisements finder, to obtain said discounts on said advertised goods and services, said medium for said advertising further comprising,
a plurality of devices for reading memory, with means to accommodate and read said memory cards, and said devices for reading memory are operatively connected to,
a plurality of displays, which display on said display any information stored on said memory cards, said devices for reading memory, is adapted for use in stores and other businesses which advertise said products and said services using said advertisements finder.

11. A device selected from a group providing advertisements, for consumers and potential consumers to use, comprising,
(a) a plurality of portable display devices each having a memory transposition port and a display disposed in said portable display device for providing updated information about products and services, on said displays, and for enabling transmission of said information from said portable display device, through said memory transposition port for said consumers to use,
(b) a computer system comprising, a program software for providing useful functions for providing said advertisements to said consumers, a input mechanisms for inputting, altering and deleting any information for use in said computer system, a computer monitor having a display screen for displaying said information inputted into said computer system using said input mechanism, and a central processing unit having a memory in which a human operator can input said information and said human operator can employ said computer system to communicate said information to said plurality of portable display devices for displaying on said displays and also for providing updated information about said products and services on said portable display devices said displays,
(c) a plurality of devices for memories disposed in said plurality of portable display devices which is able to store a plurality of characters and shapes in said plurality of portable display device said plurality of devices for memories,
(d) said input mechanism which said human operator can manipulate for communicating said Information between said plurality of portable display devices and said computer system, includes means for memory mapping so that information contained in said computer system memory can be transmitted to the plurality of portable display devices simultaneously for displaying on said plurality of portable display devices said displays,
(e) said portable display devices includes said input mechanism which users of said portable display devices can manipulate to select, store and transmit specific portions of said characters and shapes displayed on said plurality of display devices said displays,
said device selected from said group providing said advertisements further comprising,
(f) a plurality of memory cards, with means for storing said specific portions of said characters and said shapes thereof, and said device selected from said group providing said advertisements further comprising,
(g) a plurality of devices for memory reading, with means for displaying any information stored on said plurality of memory cards, and also having means for enabling transmission of said information stored on said plurality of memory cards to said computer system, and said group providing said advertisements further comprising,
(h) a memory controller operatively connected to said computer system said central processing unit which,
(1) direct any additional said characters and shapes which said human operator of said computer system enters via said computer system said central processing unit said memory to a location in said memory beginning at an address corresponding to the location between adjacent said characters and shapes displayed on said computer system said monitor said display screen, and
(2) cause all said characters and shapes in said plurality of said characters and shapes, which are stored In said memory at said addresses subsequent to said location in said memory to be transposed to said subsequent address in said memory so that said additional character and shapes can be stored in said memory at said location and before all of said subsequent characters and shapes, whereby said computer system said central processing unit said memory controller will enable said characters and said shapes to be displayed on said monitor said display screen, and said monitor said display screen can display said additional characters and shapes within said plurality of said characters and said shapes at said location between said adjacent plurality of said characters and said shapes, and whereby said human operator of said computer system can add words and said hapes within the existing body of said information and the added said words and said shapes are displayed in on orderly and clean fashion without having to reenter the existing said body of said information.

12. Said plurality of portable display devices according to claim 11, wherein a duel display screen said portable display device having a control panel comprising keys for said input mechanism theretofore.

13. Said plurality of portable display devices according to claim 11, wherein said duel display screen said portable display device having a touch screen display device comprising touch screen technology for said input mechanism theretofore.

14. Said plurality of portable display devices according to claim 11, wherein a single display screen said portable display device having said control panel comprising said keys for an input mechanism theretofore.

15. Said plurality of portable display devices according to claim 11, wherein said single display screen said portable display device having said touch screen display comprising said touch screen technology for said input mechanism theretofore.

16. Said duel display screen said portable display devices according to claims 12, and 13, wherein a conductive joiner links a right side said display screen to a left side said display screen.

17. A method of integrating advertisements on a plurality of portable visual display devices, for displaying a plurality of said advertisements which can be transmitted onto said plurality of portable visual display devices from a computer system using a program software adapted for use with said plurality of portable visual display devices, comprising,
(a) a information processing and transmitting station which includes said computer system for a human computer operator to use for inputting information into said computer system, and said computer system comprises, a plurality of computer components with devices for,
(b) providing a memory which is able to store a plurality of said advertisements at adjacent addresses in said memory,
(c) providing means to input said plurality of advertisements which said human computer operator can use to input, send and change the plurality of said advertisements in said memory at said adjacent addresses,
(d) providing a display which is operatively connected to said memory and said display will display said Plurality of advertisements stored in said memory at said adjacent addresses,
(e) providing a memory card which is able to store said advertisements for later use, providing a memory transposition port, in which said memory card is inserted for storing information from said plurality of portable display devices,
(g) providing a device for reading memory with a display screen and said memory card slot thereof, and said device for reading memory is able to retrieve and display said information on said display,
(h) providing a memory controller operatively connected in said computer system which will,
(1) direct any additional said advertisements which said human computer operator enters via said advertisements input means at a location in said memory, beginning at said address corresponding to the location between said adjacent plurality of advertisements as displayed on said display, and
(2) causing all said advertisements in the plurality of said advertisements which are stored in said computer system said processing unit said memory at said addresses subsequent said location in said memory to be transferable to said subsequent address in said memory so that said additional advertisements can be stored in said memory at said location and before all of said subsequent advertisements,
(i) said method of integrating advertisements on said plurality of portable visual display devices further comprising, said plurality of portable visual display devices operatively connected to said information processing and transmitting station, said advertisements inputted by said human operator of said information processing and transmitting station, can be readily available for displaying on said plurality of portable visual display devices,
(j) providing a device for memory in each of said plurality of portable visual display devices for storing said plurality of advertisements in a identical form as stored in said information processing and transmitting station said computer system said memory,
(k) Providing a suitable housing with means for accessing ports which enables inward and outward transmission of power and signals and also means to access said input means and further,
(l) providing a case having windows through which human users of the portable visual display devices can manipulate said input means to select any said location between any adjacent said advertisements displayed on said portable visual display devices said displays, whereby said human operator of said information processing and transmitting station may add, alter and delete advertisements in said memory for displaying on said plurality of visual display devices, and said plurality of display devices will display said additional advertisements within said plurality of advertisements at said location between said adjacent advertisements, whereby said human operator of said information processing and transmitting station can add said information within existing body of said advertisements and the added information are displayed in an orderly and clear fashion without having to reenter said existing body of said advertisements.

18. The information processing and transmitting station according to claim 17, wherein said computer components comprising a keyboard, a central processing unit, and a computer monitor, so that said human computer operator can input information into said computer components and said inputted information is transmittable to said plurality of portable visual display devices.

19. Said advertisements input means according to claim 17, wherein said keyboard is manipulated by said human computer operator to input alter and transmit said advertisements to and from said information processing and transmitting station said central processing unit said memory.

20. Said displays operatively connected to said memory according to claim 17, wherein said computer monitor is operatively connected to said central processing unit said memory which includes said memory controller for said advertisements placements in said memory in a clear and orderly fashion.

21. Said displays operatively connected to said memory according to claim 17, wherein said plurality of portable visual display devices comprises display screens and said devices for memory, said plurality of portable visual display devices is operatively connected to the information processing and transmitting station said computer components and receives inputted information from said information processing and transmitting station said computer system.

22. The housing according to claim 17, wherein a face cover and a base houses said portable visual display device, while at the same time providing a plurality of windows, for viewing said display screen, to access said memory transposition port accessible through an aperture thereof, to a control panel predetermined disposed through a face side thereof, and said housing said windows further provide access to said ports for a plurality of communicative members, and said housing further comprise a conductive center piece joiner which links a right side and a left side of a portable visual display device.

23. The case according to claim 17, wherein said case having a foldable right side flap comprising a pocket thereof, and further provide said windows for viewing said portable visual display device display screen and for enabling access to said memory transposition port and to said plurality of communicative members, and said case further comprise a inward overlapping resilient retaining skirt for keeping in place said portable visual display device.
